(19) United States
(12) Patent Application Publication
(10) Pub. No.: US 2004/0071431 A1
(43) Pub. Date: Apr. 15, 2004

(54) Guide for passing optical fibers and receiving housing for optical components fitted with one such guide

(76) Inventors: Denis Trouchet, Gieres (FR); Nicolas Krebs, St Martin d' Uriaje (FR); Alexandre Pailhes, Meylan (FR); Thierry Flahaut, St Martin d' Heres (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/469,227

(22) PCT Filed: Mar. 11, 2002
(86) PCT No.: PCT/FR02/00855

(51) Int. Cl. G02B 6/00

(52) U.S. Cl. 385/137

(57) ABSTRACT

The present invention relates to a pass guide for optical fibers. The guide (120a, 120b) comprises a plurality of adjacent grooves (122) each having a width adjusted to receive a single optical fiber and a height adjusted to receive stacking of a plurality of optical fibers.

Application to receiving cases for optical components.

### TECHNICAL FIELD

The present invention relates to a pass guide for optical fibers and a receiver case for optical components equipped with such a pass guide.

Receiver case for optical components is here understood to mean a case intended to accommodate one or possibly more optical components. These generally have a large number of inputs and/or de outputs for connecting to optical fibers.

The invention is applied particularly to systems for transmitting or processing optical signals, such as for example telecommunications networks.

### PRIOR ART

The optical components designed for optical fibers telecommunications networks generally comprise a high number of input or output terminals for injecting or extracting optical signals. A 1×N coupler, for example, distributes an incoming signal, over N output paths. It is connected to a single input optical fiber and a number N (N=32, 64 . . . ) of output optical fibers. Similarly, the function of multiplexing or demultiplexing of the optical channels of a telecommunications network multiplexed in wavelengths is realised by means of a so-called AWG component (Arrayed Waveguide Grating) typically connected to a single input fiber and to 40 output optical fibers.

The standard fibers of telecommunications networks can be packed in ribbons in which eight fibers are respectively placed side by side according to a pitch of 0.25 mm. This packaging enables components to be encased since the space requirement of the fibers on the external face of the case is then N×0.25 mm, or 10 mm for a component comprising 40 channels.

For certain applications the optical components must be connected with polarisation maintaining fibers (PM fiber) which cannot be put in the form of a strip. Each of the input or output fibers of the component must then be protected, outside the case, by a sheath, in the form of a plastic tube, known as a shrink-on tube. In this case, the space requirement of the fibers is increased.

FIG. 1 shows a case for an optical component, with an oblong pass guide 12 provided for the passage of a set of fibers 14 fitted respectively with a shrink-on tube. For the purpose of clarity the set of fibers is illustrated with a reduced number of fibers. All the same, given that the external diameter of the shrink-on tube which sheathes each fiber is typically 0.9 millimetres, the width of the set 14, for example comprising 40 fibers, is 36 millimetres. The pitch of the fibers is reduced in their connection end to the component (not shown here) as the fibers do not comprise a shrink-on tube. Therefore, in the immediate vicinity of the component, in the particular case of the integrated optics, the pitch is for example 0.25 millimetre, effectively representing a space requirement of 10 millimetres for the 40 fibers. The difference between the width of the set of sheathed fibers 14 and that of the connection end of the fibers to the component supposes that the face of the case presenting the pass guide of the fibers is sufficiently distant from the component to allow spreading of the fibers without forming a tight angle. To resolve this problem, a solution indicated in FIG. 2 consists of combining the sheathed fibers 14 to form a strand 16. As for FIG. 1, the reference numerals 10 and 12 designate respectively a case for optical components and a pass guide for the sheathed fibers. It is seen that the cylindrical guide 12 is adapted to form the strand of fibers and to keep it in place. One difficulty nevertheless appears to be keeping the fibers at the centre of the strand. Keeping the fibers at the centre of the strand is less compact than on the edge and risks compromising the reliability of the connection with the component placed in the case.

It is also seen that the cases in FIGS. 1 and 2 require modification of the pass guide, and of its dimensions, to attain a more or less high number of fibers.

### DESCRIPTION OF THE INVENTION

The aim of the present invention is to propose a pass guide for optical fibers as well as a case which is equipped therewith, not having the limitations and difficulties of the devices mentioned hereinabove.

An aim in particular is to authorise combining the fibers at the output of a case for optical components while guaranteeing a reliable connection of all the fibers.

Another aim of the invention is to guarantee optimal uptake of each fiber while reducing the dimensions of the passage for fibers of which the case for optical components is provided.

An aim is finally to benefit spreading the fibers inside the case and to reduce the dimensions of the case.

To attain these aims the invention proposes a pass guide for optical fibers comprising a plurality of adjacent grooves. Each groove has a width adjusted to take up at least one optical fiber, optionally sheathed, and a height adjusted to receive a stack of a plurality of optical fibers. The width of each groove enables reception of one or more fibers juxtaposed in terms of width.

Accordingly, in each groove, the stack of fibers according to width and height forms a group of fibers of varying geometry as a function of the section of the fibers and the dimensions of the groove.

In particular, the width of each groove can vary, which is the case especially for grooves which are V-shaped or circular.

To ensure a good grip, each groove preferably has a width adjusted to receive a single fiber.

Thus, as the adjacent grooves have a width adjusted respectively for passage of a single fiber, optionally sheathed by a shrink-on tube, they ensure that fiber is gripped optimally and individually.

The faculty of stacking the fibers in the grooves enables their dispersion to be reduced and thus facilitates formation of one or more groups of optical fibers. The grip quality of the fibers is then no longer associated with its central or peripheral position in the group.

It is appropriate to specify that the term stack is utilised without prejudging the vertical or horizontal character or any orientation of the grooves in the space.

The invention also relates to a case for components equipped with one or more pass guides such as indicated hereinabove. The case comprises, for example, a first pass guide for fibers conveying input signals, on a first face of the case and a second pass guide for fibers conveying output signals, on a second face of the case, opposite the first, for example.

The pass guide can be arranged on a mobile guide piece of the case. This piece, in which a set of grooves is placed, can, for example, be mounted in a receiving slide of the case.

The pass guide can also more simply be arranged directly in a wall of the case. The latter is then cut out to present the appropriate grooves.

The receiving case of components can be provided to receive a single component or to receive a plurality of components. The case can also be designed to receive different types of components having a variable number of optical inputs and outputs.

In this case, additional grooves can be provided, even if certain of these grooves remain unused for components associated with a reduced number of optical fibers. In other words, the pass guide of the fibers may comprise a number of grooves greater than or equal to a number of fibers to be guided, divided by a number of fibers capable of being stacked into the same groove of the guide.

The guide, which enables the fibers to be combined in a reduced space passage, thanks especially to their being stacked, also reduces the difference between dispersion of the fibers at the output and/or input of the component and cells at the output and/or input of the case. Spreading the fibers is therefore possible over a shorter distance.

The dimensions of the case, and thus its space requirement, can be reduced in this way.

Preferably, a wall of the case with the pass guide and placement provided for the component are separated by an adequate distance to allow optical fibers to be spread between the component and the grooves of the guide with radius of curvature greater than or equal to a determined radius Ro, for example 25 mm. The radius Ro can be selected as a function of the characteristics of the fibers and especially of the diameter of the core of the fibers, of the index contrast and the index profile. By way of example, for monomode Telecom fibers of the type marketed under reference SMF 28, the radius Ro is selected substantially equal to 25 mm.

Other characteristics and advantages of the invention will emerge from the following description, with reference to the figures in the attached drawings. This description is given purely illustratively and as non-limiting.

### BRIEF DESCRIPTION OF THE DRAWINGS

FIG. 1 already described, is a diagrammatic view of a case for a component, known, provided with a passage for a set of sheathed optical fibers.

FIG. 2 already described, is a diagrammatic view of a known case with a single cylindrical passage for input and output optical fibers sheathed in a protective shrink-on tube, and combined to form one strand.

FIG. 3 is a diagrammatic view of a case according to the present invention.

FIG. 4 is a view on an enlarged scale of a detail of a pass guide for optical fibers according to the present invention.

FIG. 5 diagrammatically illustrates spreading of an optical fiber between a component and a pass guide of a case.

FIGS. 6 and 7 are partial diagrammatic views of cases according to the present invention and illustrate different variant embodiments of pass guides.

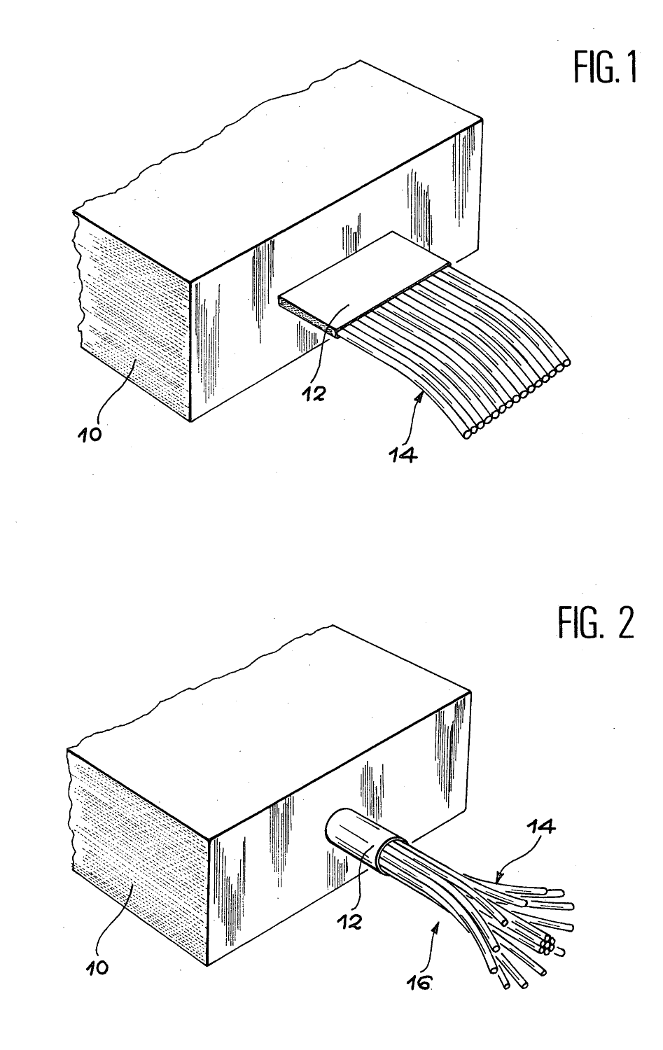

### DETAILED DESCRIPTION OF EMBODIMENTS OF THE INVENTION

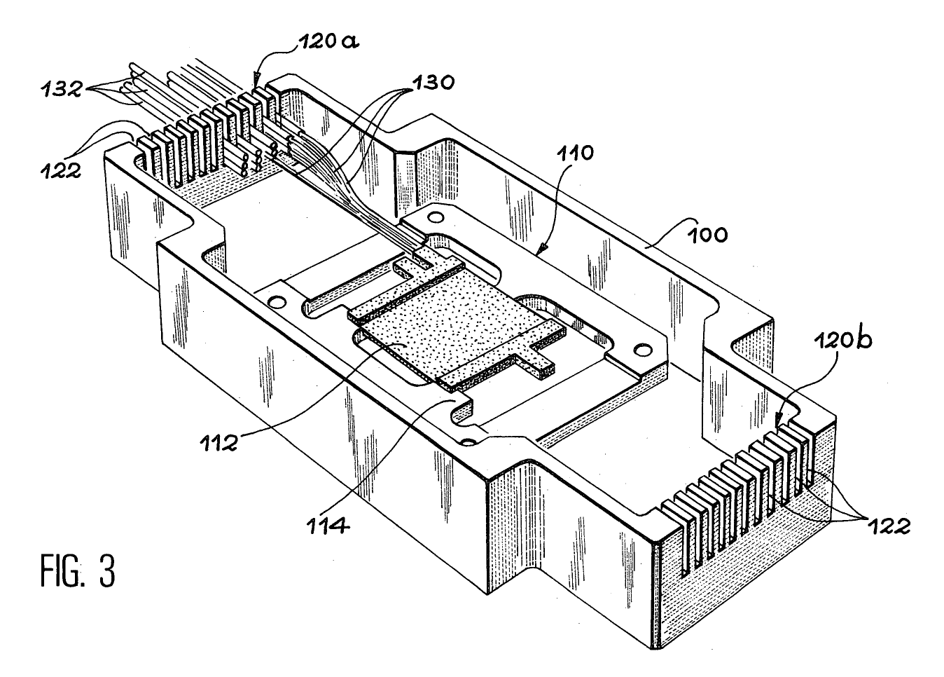

FIG. 3 shows a case 100 according to the present invention. The case 100 is made of a stiff material such as metal or a plastic material. Its essential function is in fact to protect an optical component and optical fibers. The optical fibers are in fact not sheathed, and are thus fragile, in the vicinity of the component.

By way of example, the case can be made of aluminium, Delrin (plastic material), Kovar or Invar (Fe—Ni alloys) The list of these materials is certainly not exhaustive.

In its central part, the case 100 has a region 110 for receiving one or more components 112. Fasteners 114 for holding the component can be provided for this purpose to attach to the support substrate of the component.

In the example in FIG. 3, the case comprises two pass guides of fibers 120a, 120b, arranged respectively in two opposite lateral walls. The guides 120a and 120b are intended, for example, for input optical fibers, connected to inputs of the component, and to output optical fibers connected to outputs of the component.

Each of the pass guides comprises a plurality of parallel grooves 122 forming a holding comb for the fibers.

The grooves are made directly in the wall in the form of cut-outs whereof the width corresponds approximately to the diameter of at least one preferably sheathed fiber. (In this example, the width of the groove is adapted to comprise one sheathed fiber only).

It can be observed in FIG. 3 that the fibers 130 are provided with a sheath 132 in the region of the pass guide and outside the case, whereas they are not sheathed in the region of the component itself. For the sake of clarity only a reduced number of fibers and sheaths is shown. Similarly, a cover of the case, deliberately omitted in this figure, is generally provided.

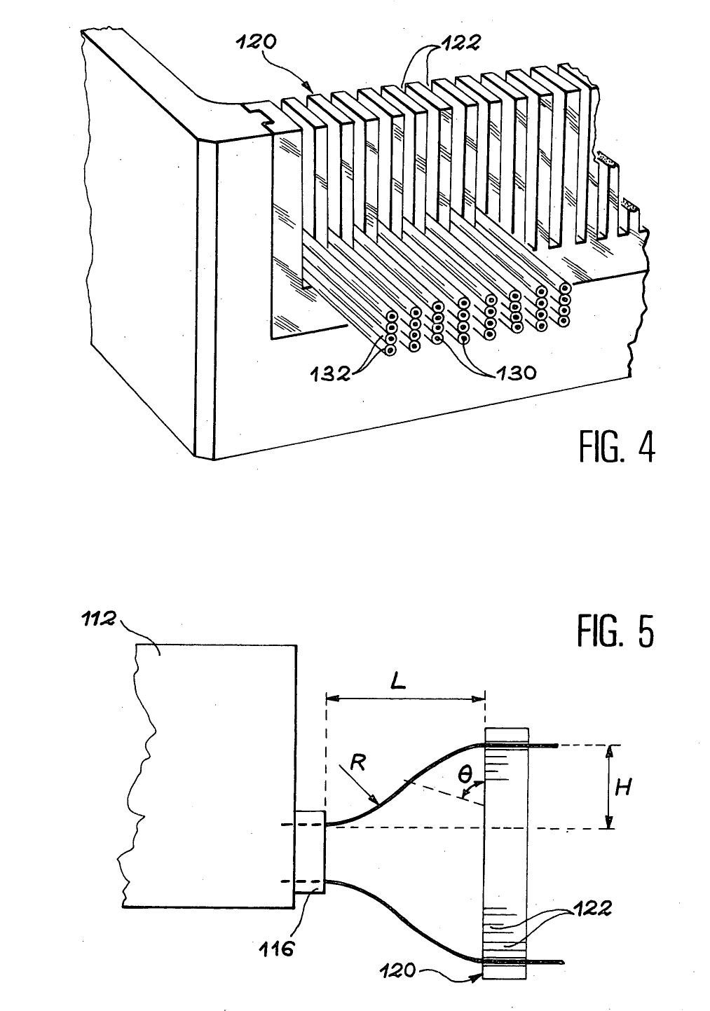

FIG. 4 shows another possibility for an embodiment of the invention. A pass guide 120, mobile, is held in an opening of the case, for example, by a nesting system of a slide in a throat. Due to this particularity the pass guide can be replaced by a guide having more or fewer grooves, grooves more or less wide, adapted to the non-sheathed fibers or sheathed fibers of different diameters, or even grooves more or less deep and of varying geometry.

It is also observed in FIG. 4 that in the same groove 122, the fibers 130, each enclosed by a sheath 132, are stacked on one another.

The dimensions of the grooves are adapted to the diameter of a given type of sheath or fibers, and the maximum number of fibers to be combined in the groove, in particular in the direction of the width of the groove.

The spacing between the fibers of one groove and the following groove is dictated by the pitch of the grooves, that is, the width of the ‘teeth’ of the comb, separating the grooves.

By way of illustration, for fibers whereof the sheath has an external diameter of 0.9 mm, the grooves 122 can have a width of 1 mm and be arranged according to a regular pitch of 1.5 mm. The thickness of the teeth of the comb separating two grooves is thus 0.5 mm.

The height of the grooves is preferably a multiple of the external diameter of the fibers. It can be limited for example by a cover of the case, not shown here, which keeps the fibers in the grooves.

In addition, to improve the grip of the fibers in the grooves, the latter are advantageously fixed therein by way of adhesion.

FIG. 5 shows the spread of a fiber between a component 112 and a pass guide 120 of a case according to the present invention.

At the output of the component, the fibers are not sheathed, such that their diameter is less. They can therefore be juxtaposed according to a reduced pitch. This pitch is fixed for example by a glass or silicon substrate in which a network of cuts in a V shape is etched or machined. Each cuts takes up one fiber whereof the end is stripped, that is, deprived of a sheath. The fibers are held in the cuts by adhesion or by means of a counter-blade. The cuts coincide with guided optical paths of the component, for example.

In FIG. 5, the connection terminal of the fibers on the component is shown schematically by reference numeral 116. The pitch of the fibers at the output of the component is noted as P₁. The pitch of the fibers in the pass guide is noted as P₂.

In this example of spreading the fibers, the total width of the connection on the component is for example N×P₁=10 mm where N is the number of juxtaposed fibers.

The width of the pass guide is

$$\frac{N x {P}_{2}}{M}$$

is the number of (sheathed) fibers superposed in each groove.

By designating as L the distance separating the connection terminal from the pass guide, R the radius if curvature of the fibers, and B the angle described by the arcs of a circle enabling spreading of the end fibers relative to the general axis of output of the fibers, the spread N is such that

$$H = 2 R [ 1 - cos ( Θ ) ] = \frac{[ ( N \geq • {P}_{2} ) / M - N {P}_{1} ]}{2}$$

with P₂=1.5 mm, P₁=0.25 mm, N=40 and M=4, the value H is: H=2.5 mm at consequently Θ=18° by limiting the radius of curvature to a minimum of 25 mm. This calculation supposes that the pass guide is centred relative to the connection terminal.

Under these conditions, the length of the spread section is:

L=2R[ sin(Θ)]=15 mm

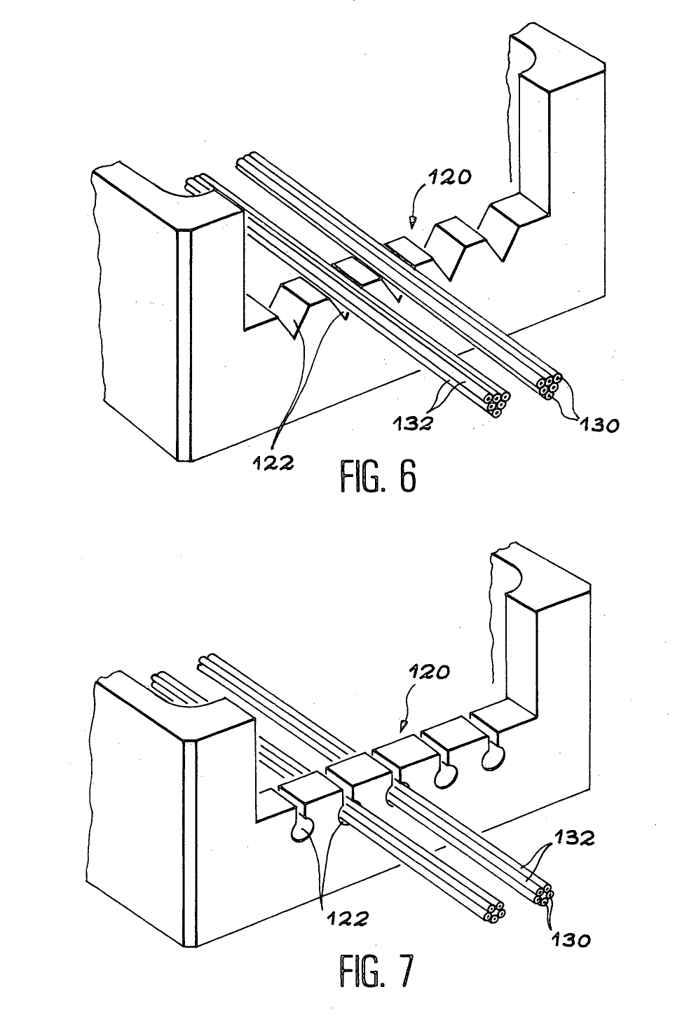

FIGS. 6 and 7 show cases with pass guides in a form different to that in FIG. 4. The reference numerals for identical or similar parts of FIGS. 4, 6 and 7 are nevertheless the same.

The grooves 122 of the guide of FIG. 6 have a V shape, whereas those in FIG. 7 have a circular opening surmounted with a setting throat of the fibers.

Contrary to the pass guide of FIG. 4, the pass guides of FIGS. 6 and 7 allow several fibers to be taken up side by side.

1. A case for optical components having a placement (110) for at least one optical component and provided with at least one pass guide (120) for optical fibers, characterised in that the guide comprises a plurality of adjacent grooves (122) each having a width adjusted to take up at least a single optical fiber and a height adjusted to take up a stack of a plurality of optical fibers.

2. The case as claimed in claim 1, in which the width of each groove (122) is adjusted to take up a single fiber, and this width is substantially equal to the diameter of an individual optical fiber enclosed by a protective sheath.

3. The case as claimed in claim 1, comprising grooves of rectangular, circular and/or V shape.

4. The case as claimed in claim 1, characterised in that the pass guide for optical fibers is arranged in a wall of said case.

5. The case as claimed in claim 1, characterised in that the pass guide for optical fibers is arranged in a mobile guide piece of the case.

6. The case as claimed in claim 1, provided with at least two pass guides (120a, 120bp) for optical fibers, arranged in opposite walls of the case.

7. The case as claimed in claim 1, having at least one wall provided by the pass guide to optical fibers, in which the wall and the placement for components (110) are separated by a distance (L) sufficient to allow spread of optical fibers between the component and the grooves of the guide with a radius of curvature greater than or equal to 25 mm.

8. The case as claimed in any one of the preceding claims, characterised in that the pass guide and placing of the component are separated by a distance (L) sufficient to allow spread of optical fibers between the component and the grooves of the guide with a radius of curvature greater than or equal to a determined radius Ro.

9. The case as claimed in claim 8, characterised in that the radius Ro is substantially equal to 25 mm.

10. The case as claimed in any one of the preceding claims, characterised in that the optical component is an integrated optic component.

11. The case as claimed in claim 1, characterised in that the pass guide for optical fibers comprises a number of grooves greater than or equal to a number of fibers to be guided divided by a number of fibers capable of being stacked in the same groove of the guide.

12. The case as claimed in claim 1, equipped with optical fibers passing through the pass guide, characterised in that the fibers are fixed by adhesion in the grooves of the guide.
